(19) United States
(12) Patent Application Publication
(10) Pub. No.: US 2004/0244587 A1
(43) Pub. Date: Dec. 9, 2004

(54) Use of planar textile structures comprising textured yarns as protection against pollen for windows and doors

(76) Inventor: Andreas Schroder, Hamburg (DE)

Correspondence Address: NORRIS, MCLAUGHLIN & MARCUS, PA, 875 THIRD STREET, 18TH FLOOR, NEW YORK, NY, 10022, US

(21) Appl. No.: 10/380,410

(22) PCT Filed: Oct. 23, 2001
(86) PCT No.: PCT/EP01/12213

(30) Foreign Application Priority Data
Oct. 26, 2000 (DE) 100 53 228.4

(51) Int. Cl. A47H 33/00; B01D 46/00

(52) U.S. Cl. 95/273; 160/405; 55/490

(57) ABSTRACT

The use of textile fabric which contains textured yarn material for attachment in front of windows or doors to guard against dusty allergens such as pollen or house dust.

This application is a 371 of PCT/EP01/12213, filed on Oct. 23, 2001.

This invention relates to a textile fabric which is formed from textured yarn material and which is used as a guard against the penetration of dusty, airborne allergens such as pollen and fungal spores into living and working areas by attachment in front of windows and doors over the whole area thereof.

The incidence of pollinosis (hay fever), ie the allergic reaction of the mucous membranes of the eye and of the upper and lower respiratory tracts with flower pollen and other airborne allergens, in the population has been monitored in Germany for a number of years. It was found that about 11-15% of the population is affected. The allergic reaction of a pollen allergy usually manifests itself in reddening and lacrimation of the eyes (conjunctivitis), sneezing episodes (rhinitis) and a dry cough (bronchial asthma) as early reactions. Known late reactions to pollen allergy include for example neurodermatitis or eczema. As well as the personal symptoms of sufferers, there are more far-reaching consequences such as loss of earnings or work incapacity during the pollen season or increased medical treatment costs, so that there is an immense need for a gridlike pollen guard within the meaning of the invention for attachment in front of the windows and doors of living and working areas. Further information about pollinosis is available in Ratgeber Pollenallergie, Ute Kunkele, Munich 1992.

The most important properties a pollen guard for windows and doors must offer the user are: sufficient ability to air the amenities, sufficient transparency for letting light in and for looking out, and an alleviating effect with regard to pollen allergy. The most important parameters for describing a pollen guard are accordingly: air perviousness, optical transparency and filtering effect with regard to pollen.

Guard systems attached in front of windows and doors over the whole area thereof in order that the penetration of comparatively large objects such as insects into living areas may be prevented are known (=flyscreens). DE 3045723 describes for example net curtains, nets, filters or sieves for such a purpose that are attached to window or door frames by means of press studs. Owing to their relatively large mesh sizes of 1-2 mm, these do not provide adequate protection against pollen (size about 10-50 μm) and fungal spores (size about 200 μm).

Filtration means whereby air is completely cleaned of pollen, germs and spores find use in airconditioning and automobiles. The high filtering effect is achieved in DE 3904623 for example through the use of single- or else often multi-ply filter mats formed from nonwovens which, owing to their fibrous nature, make the filter stage impassable to the abovementioned allergens. To intensify the contact of the particle-laden air with the filter, the laminate of filter mats is additionally folded in a zigzag shape. However, owing to their nonexistent visual transparency, such filter mats have no utility as a protective or guard apparatus within the meaning of the present invention. In addition, such filters for airconditioning systems in automobiles give rise to substantially higher back pressures than with the use in front of the window area by the incident air movement, so that filter fleeces have to be used. A use of filter fleeces in front of windows over the whole area thereof is not suitable as a pollen guard within the meaning of this invention because of the lack of visual transparency.

A further window guard against pollen, germs and spores is disclosed for example in DE 4300422. A textile material is attached in front of the windowpane, not over the whole area thereof, but in the two wedgelike interstices and also the rectangular opening at the upper side of a window in tilt position. This form of attachment circumvents the problem of the nonexistent visual transparency of the textile material, but to completely open the window for airing purposes the textile material has to be removed, so that there is no longer any protective effect.

It is further possible to remove pollen from air flowing into an indoor amenity by means of a woven or loop-formingly knitted fabric solely by adjusting the mesh size. The sizes of most of the allergenic pollens occurring in Europe, essentially birch, grasses, goose-foot, wormwood, plantain, hazel, are in the region of 20-40 μm. The necessary mesh size for purely mechanical filtration is therefore at least 20 μm, and this is too small to provide visual transparency and air perviousness.

It is an object of the present invention to actualize the properties of air perviousness, visual transparency and adequate filtering effect with regard to pollen in one protective system. The pollen protective system or guard shall combine an adequate filtration efficiency of 70-80% with regard to pollen with adequate ventilation and adequate visual transparency. Good values of air perviousness for acceptable ventilation of a room are of the order of not less than 20 000 m³/m²/h given a differential pressure of 300 Pa. Adequate transparency within the meaning of the invention is a transmission between 20 and 100%. This object of adequate visual transparency and air perviousness coupled with adequate filtering performance is achieved through the use of a textile fabric in which the yarn material is exclusively or partially replaced by textured threads.

The texturing of yarn material is primarily used for textile fabrics formed from manufactured fibers such as polyester or polyamide in order that a character resembling a natural fiber may be conferred on the artificial fibers. Manufactured fibers differ from natural fibers with regard to the spinning into yarns, in the length of the filaments to be spun into yarns. Manufactured fibers are used in the form of continuous filaments which, after spinning into yarn, have a parallel position relative to each other and confer a smooth feel on the yarn. The filament length of natural fibers is substantially shorter and only amounts to a few centimeters. When short filament lengths are spun into yarn, as in the case of cotton for example, the yarn acquires bulk by virtue of the protruding filament ends.

The texturing of yarn material composed of artificial endless filaments can be effected for example by deforming the filaments from their parallel position by torsion or bending with subsequent heatsetting. An example is the so-called false twisting process [Grundlagen der Textilveredelung”, 13th revised edition, Deutsch Fachbuchverlag 1989].

Textile fabric refers to the totality of ways of producing textiles from yarn material by conventional fabric-forming operations such as drawn-loop knitting, formed-loop knitting or weaving. The fundamentals of textile fabric-forming operations can be researched in Alfons Hofer: “Stoffe 2”, 1983, Deutsch Fachbuchverlag or “Kettwirkpraxis”, No. 4, 1970, pages 19-20, Technologien der Kettwirkerei.

Textile fabrics in manufactured fibers such as polyester with textured yarn material are frequently used, on account of their pleasant hand, for apparel purposes for example as front appliques in the high-ticket outerwear sector. The use as a pollen guard in front of window areas and door openings and also for other air inlets is a new field of application and is to be protected.

The use of a textile fabric with textured threads has the advantage over the cited approach of achieving a filtration of pollen solely by reducing the mesh size that a higher filtering effect can be achieved without process-side reduction in the mesh size, since the filaments of the textured thread narrow the actual mesh size and this creates spacings between the filaments that are impassible for pollen. In addition, the swelling results in the two-dimensional fabric being extended into the third dimension. The textured threads thus on the one hand, through a longer flow path, extend the contact time of the air with the filter material and on the other enlarge the filter surface area, which leads to improved filter properties.

This permits for example a higher air perviousness which enables improved airing of the amenities, since the mesh size does not have to be reduced to the diameter of the pollen to be filtered to achieve filtering.

1. Cancelled.

2. A method of guarding against the ingress of a dusty allergen through a window or door, said method comprising attaching a textile fabric comprising textured yam material to a front of said window or door.

3. The method according to claim 2, wherein the dusty allergen is pollen.

4. The method according to claim 2, wherein the dusty allergen is house dust.

5. The method according to claim 2, wherein the textile fabric consists entirely or partially of textured threads.

6. The method according to claim 2, wherein the textile fabric is attached to a front of a window.

7. The method according to claim 2, wherein the textile fabric is attached to the front of a door.

8. A combination comprising a window or door having a textile fabric comprising textured yarn material attached to a front thereof.

9. The combination according to claim 8, which is a window having the textile fabric attached to a front thereof.

10. The combination according to claim 8, which is a door having the textile fabric attached to a front thereof.

11. The combination according to claim 8, wherein the textile fabric consists entirely or partially of textured threads.
